(19) United States
(12) Patent Application Publication
(10) Pub. No.: US 2005/0183878 A1
(43) Pub. Date: Aug. 25, 2005

(54) Plenum cable

(76) Inventors: Tom A. Herbort, Cincinnati, OH (US); Alben D. Roland, Cincinnati, OH (US)

Correspondence Address: BLANK ROME LLP, 600 NEW HAMPSHIRE AVENUE, N.W., WASHINGTON, DC, 20037, US

(21) Appl. No.: 10/782,824

(22) Filed: Feb. 23, 2004

(51) Int. Cl. H01B 11/02

(52) U.S. Cl. 174/110 R; 174/116

(57) ABSTRACT

The present invention relates to cables suitable for use in plenum applications, which exhibit flame spread and smoke generation properties that comply with industry standards, such as UL 910 or NFPA 262. The cable contains a conductor core that is wrapped with a filament in a spiral pattern along the length of the conductor. A dielectric is then extruded over the filament-wrapped conductor core to provide an insulated cable. To form a coaxial cable, a second conductor can also be provided on the outside of the dielectric and then covered with a jacket. The filament, dielectric, and jacket are preferably made of polyvinyl chloride (PVC).

### FIELD OF THE INVENTION

The present invention relates generally to cables suitable for use in plenum applications. In particular, the present invention relates to coaxial cables suitable for use in plenum applications, which exhibit flame spread and smoke generation properties that comply with industry standards, e.g., UL 910 or NFPA 262.

### BACKGROUND OF THE INVENTION

Buildings are usually designed with a space between a drop ceiling and a structural floor from which the ceiling is suspended to serve as a return air plenum for elements of heating and cooling systems as well as serving as a convenient location for the installation of communications cables and other equipment, such as power cables. Alternatively, the building can employ raised floors used for cable routing and plenum space. Communications cables generally include voice communications, data and other types of signals for use in telephone, computer, control, alarm, and related systems, and it is not uncommon for these plenums and the cables therein to be continuous throughout the length and width of each floor, which can introduce safety hazards, both to the cables and the buildings.

When a fire occurs in an area between a floor and a drop ceiling, it may be contained by walls and other building elements which enclose that area. However, if and when the fire reaches the plenum space, and especially if flammable material occupies the plenum, the fire can spread quickly throughout the entire floor of the building. The fire could travel along the length of cables which are installed in the plenum if the cables are not rated for plenum use, i.e., do not possess the requisite flame and smoke retardation characteristics. Also, smoke can be conveyed through the plenum to adjacent areas and to other floors with the possibility of smoke permeation throughout the entire building.

As the temperature in a non-plenum rated jacketed cable rises, charring of the jacket material begins. Afterwards, conductor insulation inside the jacket begins to decompose and char. If the charred jacket retains its integrity, it still functions to insulate the core; if not, however, it ruptures due either to expanding insulation char or to pressure of gases generated from the insulation, and as a consequence, exposes the virgin interior of the jacket and insulation to the flame and/or the elevated temperatures. The jacket and the insulation begin to pyrolize and emit more flammable gases. These gases ignite and, because of air drafts in the plenum, burn beyond the area of flame impingement, thereby propagating flame and generating smoke and toxic and corrosive gases.

Because of the possibility of flame spread and smoke evolution, as a general rule, the National Electrical Code (NEC) requires that power-limited cables in plenums be enclosed in metal conduits. However, the NEC permits certain exceptions to this requirement. For example, cables without metal conduits are permitted, provided that such cables are tested and approved by an independent testing agent, such as Underwriters Laboratories (UL), as having suitably low flame spread and smoke generating or producing characteristics. The flame spread and smoke production of cables are measured using the UL 910, also known as the “Steiner Tunnel,” standard test method or, more recently, the NFPA 262 flame test for fire and smoke retardation characteristics of electrical and optical fiber cables used in air handling spaces, i.e., plenums.

Communication systems in the present day environment are of vital importance, and, as technology continues to become more sophisticated, such systems are required to transmit signals substantially error free at higher and higher bit rates. More particularly, it has become necessary to transmit data signals over considerable distances at high bit rates, such as megabits or gigabits per second, and to have substantially error free transmission. Thus, desirably, the medium over which these signals are transmitted must be capable of handling not only low frequency and voice signals, for example, but higher frequency data and video signals. In addition, one aspect of the transmission that must be overcome is crosstalk between pairs of commercially available cables. One of the most efficient and widely used signal transmission means which has both broadband capability and immunity from crosstalk interference is the well known coaxial cable.

The coaxial cable comprises a center conductor surrounded by an outer conductor spaced therefrom, with the space between the two conductors comprising a dielectric, which may be air but is, most often, a dielectric material such as foamed polyethylene. The coaxial cable transmits energy in the transverse electromagnetic (TEM) mode, and has a cut-off frequency of zero. In addition, it comprises a two-conductor transmission line having a wave impedance and propagation constant of an unbounded dielectric, and the phase velocity of the energy is equal to the velocity of light in an unbounded dielectric. The coaxial line has other advantages that make it particularly suited for efficient operation in the HF and VHF regions. It is a perfectly shielded line and has a minimum of radiation loss. It may be made with a braided outer conductor for increased flexibility and it is generally impervious to weather effects. Inasmuch as the line has little radiation loss, nearby metallic objects and electromagnetic energy sources have minimum effect on the line as the outer conductor serves as a shield for the inner conductor. As in the case of a two-wire line, power loss in a properly terminated coaxial line is the sum of the effective resistance loss along the length of the cable and the dielectric loss between the two conductors. Of the two losses, the resistance loss is the greater since it is largely due to skin effect and the loss will increase directly with the square root of the frequency.

The most commonly used coaxial cable is a flexible type having an outer conductor consisting of copper or aluminum wire braid, with the copper or copper clad steel inner conductor supported within the outer conductor by means of the dielectric, such as foamed or expanded polyethylene (FMPE), which has excellent low-loss characteristics. The outer conductor is protected by a jacket of a material suitable for the application, such as, for example, for non-plenum use, poly(vinyl chloride) (PVC) or polyethylene (PE).

The coaxial cable most preferred for its performance characteristics for non-plenum uses has an FMPE dielectric and PVC jacket. However, the use of FMPE dielectric material and a PVC jacket generally does not result in a cable that satisfies UL 910. The use of foamed fluorinated ethylene polymers, such as polytetrafluoroethylene (PTFE) and fluorinated ethylene-propylene polymer (FEP), both sold under the trademark TEFLON™, has been suggested for the dielectric material due to its low flame spread and low smoke emission characteristics. However, those materials are generally expensive and/or in short supply, and thus are unsatisfactory from an economic standpoint, although outstanding for their flame and smoke retardation characteristics.

In general, highly flame retardant cable jackets have been made in two ways. An inert flame retardant additive such as antimony or molybdenum can be added to an appropriate polymer, such as PVC. Alternatively, or perhaps in combination, a halogenated polymer, such as FMPE and FEP, that is inherently flame retardant, can be used alone or as a copolymer. Both of those methods are also expensive and require specialized processing equipment.

It is apparent from the foregoing discussion that there remains a need for an inexpensive, flame retardant, and low-smoke generating coaxial cable that has excellent electrical transmission capabilities, is easy to manufacture, and does not sacrifice transmission properties for fire and smoke resistance.

### SUMMARY OF THE INVENTION

It is an object of the present invention to provide an improved cable which is suitable for plenum applications and which is flame resistant and low-smoke generating.

A further object of this invention is to provide an improved plenum cable which is constructed at a low cost using inexpensive materials.

It is a further object of the invention to provide an improved plenum cable which is suitable for plenum applications but is free of fluoropolymers.

A further object of the invention is to provide an improved plenum cable which is suitable for plenum applications and which can be efficiently and economically manufactured.

Other objects and advantages of the invention will be apparent from the following detailed description and the accompanying drawings.

The present invention provides flame retardant and low-smoke cables using inexpensive materials. However, the inventive construction of the cables provides flame retardant and low-smoke characteristics without requiring expensive materials that are inherently flame retardant or contain flame retardant additive.

In accordance with the present invention, the foregoing objectives are realized by providing a cable containing a conductor core that is wrapped with a filament in a spiral pattern along the length of the conductor. A dielectric is then extruded over the filament wrapped conductor core to provide an insulated cable. To form a coaxial cable, a second conductor can also be provided on the outside of the dielectric and then covered with a jacket. The filament, dielectric, and jacket are preferably made of polyvinyl chloride (PVC).

Methods of making the novel plenum cable are also provided.

### BRIEF DESCRIPTION OF THE DRAWINGS

FIG. 1 is a drawing showing the cable of the present invention;

FIG. 2 is a drawing showing the cross-section of the cable of FIG. 1; and

FIG. 3 is a drawing showing the cross-section of a coaxial cable constructed from the cable of the present invention.

### DETAILED DESCRIPTION OF THE PREFERRED EMBODIMENTS

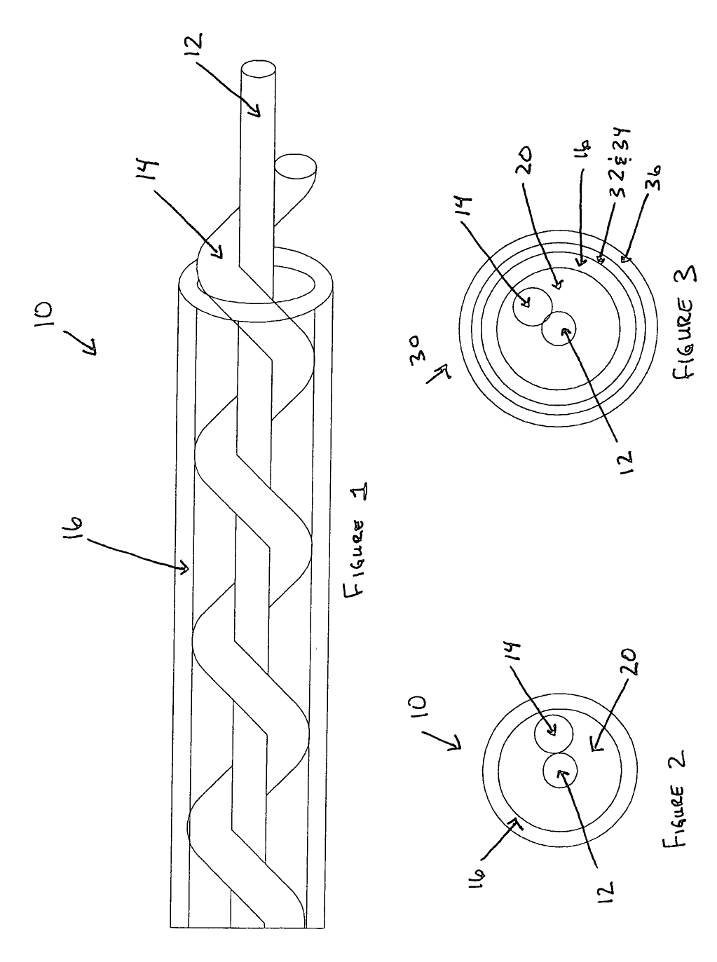

As shown in FIG. 1, the cable 10 of the present invention has a core conductor 12, at the center of the cable. The core conductor 12 is wrapped with a filament 14 in the shape of a spiral. The spiral wrap preferably has about 20-30 twists/foot, most preferably about 24 twists/foot. The core conductor 12 is generally a smooth conducting material such as copper, tinned copper, aluminum or copper-clad steel. The filament 14 is preferably made of a polymeric material which has a low dielectric loss so that it does not significantly attenuate the signals propagated through the cable. The filament 14 be made from, but is not limited to, polyvinyl chloride (PVC), aramid fiber (such as KEVLAR®), fluoropolymer (such as VATAR®), glass, ethylene chlorotrifluroethylene (ECTFE) polymers, vinylidene fluoride (PVDF) copolymer, or combinations thereof. The filament 14 is preferably a fiber having a diameter of about 0.03-0.06 in. Although the filament 14 generally has a circular cross-section, any equivalent cross-sections are also appropriate to the present invention, such as square, rectangular, triangular, etc.

The filament-wrapped conductor is surrounded by an insulator 16 which covers the entire core conductor 12 and the filament 14 that is wrapped around the core conductor 12. When the insulator surrounds the filaments air gaps 20 develop adjacent to the filament, between the core conductor 12 and the insulator (see FIG. 2), which reduces the effective dielectric constant of the insulator 16. It is preferred that the effective dielectric constant of the insulator 16 be about 1.4 to about 2. Therefore, the filament 14 is wrapped such that there is greater than about 40% air present when the insulator surrounds the filament wrapped core conductor.

The insulator 16 is preferably constructed of PVC or fluoropolymer (such as VATAR®) that is extruded over the filament-wrapped core conductor. The insulator 16 can be constructed of a different or the same material as that of the filament 14. The most preferred filament/insulator combinations are PVC/PVC, HALAR®/PVC, and SOLEF®/PVC. HALAR® is trade name for plasticized ethylene chlorotrifluroethylene (ECTFE) polymers; and SOLEF® is a trade name for vinylidene fluoride (PVDF) copolymers. The insulator 16 can be applied to the filament-wrapped core conductor by tapewrapping, extruding, or other means known in the art, with extrusion being the preferred method of applying the insulator 16 over the filament-wrapped core conductor. The insulator 16 preferably has a thickness of about 0.010-0.020 in., most prefereably about 0.015 in.

It is preferred that the dielectric material used to form the insulator 16 be a non-halogenated, non-flame-retardant material, preferably polyvinyl chloride (PVC) or a polyolefin such as polyethylene. The additives that are used to make a dielectric polymer flame-retardant increase the dielectric constant; and thus, dielectric materials that do not contain flame-retardant additives are preferred. Crosslinking of a polymer can also improve its fire-retardant properties, but also has an adverse effect on the transmission characteristics of the cable and, therefore, is undesirable. It is especially preferable to use a dielectric polymer which is non-halogenated so as to avoid the generation of toxic or corrosive fumes when the cable is burned. The danger of toxic or corrosive fumes can be even greater than the danger of the fire itself Further, as discussed in the previous section, halogenated polymers, such as FEP, and polymers containing flame retardant additives are generally expensive and are not economically desirable.

In a preferred embodiment, the cable of the present invention is used in a coaxial cable 30 (FIG. 3). In such case, the insulator 16 is surrounded by an outer conductor which is preferably copper (tinned or bare) or aluminum and contains, preferably, an aluminum tape (32) surrounded by a copper braid (34). Although the braid is preferably copper (tinned of bare), aluminum is also appropriate. Further, the braid preferably has an optical coverage of about 40-90%. In that configuration, the core conductor 12 and the outer conductor are in parallel spaced apart relation with the outer conductor forming a cylinder and the core conductor 12 being at the axis of the cylinder. The outer conductor and the core conductor 12 are separated by the insulator 16.

To complete the coaxial cable, a jacket 36 surrounds the outer conductor. The jacket 36 is preferably made of a flame retardant material, such as, but is not limited to, halogenated polymers (FEP, ECTFE, or PVDF) or flame retardant PVC. The jacket 36 can be extruded or wrapped over the outer conductor. Besides flame retardant protection, the jacket also provides mechanical and chemical protection from environmental assaults.

### EXAMPLE

A coaxial cable was constructed in accordance with the Standard for Communications Cable, UL 444/CSA-C22.2 No. 214. The conductor (No. 20 AWG or larger) was helically wrapped with a filament at a lay length of 0.6±0.2 in. The filament contained PVC extruded over a ripcord employing nylon, KEVLAR, polyester, or fiberglass, with a minimum thickness of 9 mils and a maximum average thickness of 15 mils. The insulator surrounding the filament-wrapped conductor was PVC with a minimum average thickness of 28 mils, minimum thickness of 25 mils, maximum average thickness of 39 mils, and a maximum overall tube diameter of 205 mils. The outer conductor comprised a shield and a braid. The shield consisted of metal, bimetal, aluminum/polyester or aluminum/polyester/aluminum tape which is 2±1 mils thick with a maximum overlap of 25%. The tape is applied longitudinally or helically over the cable core. The braid is tinned copper, bare copper or aluminum braid with 40% minumum coverage. The jacket is PVDF with a minimum average thickness of 13 mils, minimum thickness of 10 mils and maximum average thickness of 20 mils.

The cable was flame tested in accordance with NFPA 262. The result obtained is depicted in TABLE 1, which showed that the cable complied with the UL requirements for flame and smoke retardation.

TABLE 1

| | | | Maximum | | |
|---|---|---|---|---|---|
| | | | Flame | | |
| | | | Propagation | | |
| | Cable O.D. | No. of | Distance | Optical Density | |
| Test No. | (in.) | Lengths | (ft.) | Peak | Average |
| 1 | 0.235 | 47 | 1.5 | 0.23 | 0.11 |
| 2 | 0.235 | 47 | 1.5 | 0.22 | 0.11 |

The invention has been disclosed broadly and illustrated in reference to representative embodiments described above. Those skilled in the art will recognize that various modifications can be made to the present invention without departing from the spirit and scope thereof.

1. A cable comprising
a conductor core;
a filament wrapped around the conductor core in a spiral pattern; and
an insulator surrounding the filament-wrapped conductor core.

2. The cable of claim 1, wherein the conductor core is tinned copper, bare copper, or copper clad steel.

3. The cable of claim 1, wherein the filament is made of PVC.

4. The cable of claim 1, wherein the insulator is PVC.

5. The cable of claim 1, wherein the insulator is extruded over the filament wrapped conductor core.

6. The cable of claim 1, wherein air is trapped adjacent to the filament resulting in a decrease in effective dielectric constant for the insulator.

7. The cable of claim 6, where in the effective dielectric constant of the insulator is about 1.4 to about 2.

8. The cable of claim 1, further comprising a second conductor surrounding the insulator.

9. The cable of claim 8, wherein the second conductor is braided.

10. The cable of claim 8, further comprising a shielding material disposed between the second conductor and the insulator.

11. The cable of claim 10, wherein the shielding material is an aluminum/mylar tape.

12. The cable of claim 8, wherein a jacket surrounds the second conductor.

13. The cable of claim 12, wherein the jacket is flame retardant.

14. A method for making a cable comprising the steps of
a) providing a conductor core;
b) wrapping a filament over the conductor core in a helical pattern; and
c) surrounding the filament-wrapped conductor core with an insulator.

15. The method of claim 14, wherein the conductor core is tinned copper, bare copper, or copper clad steel.

16. The method of claim 14, wherein the filament is made of PVC.

17. The method of claim 14, wherein the insulator is PVC.

18. The method of claim 14, wherein the insulator is extruded over the filament wrapped conductor core.

19. The method of claim 14, wherein air is trapped adjacent to the filament resulting in a decrease in effective dielectric constant for the insulator.

20. The method of claim 19, where in the effective dielectric constant of the insulator is about 1.4 to about 2.

21. The method of claim 14, further comprising the step of surrounding the insulator with a second conductor.

22. The method of claim 21, wherein the second conductor is braided.

23. The method of claim 21, further comprising step of providing a shielding material between the second conductor and the insulator.

24. The method of claim 23, wherein the shielding material is an aluminum/mylar tape.

25. The method of claim 23, further comprising surrounding the second conductor with a jacket.

26. The method of claim 25, wherein the jacket is flame retardant.

27. A coaxial cable comprising
a conductor core;
a filament wrapped around the conductor core in a spiral pattern;
an insulator surrounding the filament-wrapped conductor core;
a second conductor surrounding the insulator; and
a jacket surrounding the second conductor.

28. The coaxial cable of claim 27, wherein the conductor core is tinned copper, bare copper, or copper clad steel.

29. The coaxial cable of claim 27, wherein the filament is made of PVC.

30. The coaxial cable of claim 27, wherein the insulator is PVC.

31. The coaxial cable of claim 27, wherein the insulator is extruded over the filament wrapped conductor core.

32. The coaxial cable of claim 27, wherein air is trapped adjacent to the filament resulting in a decrease in effective dielectric constant for the insulator.

33. The coaxial cable of claim 32, where in the effective dielectric constant of the insulator is about 1.4 to about 2.

34. The coaxial cable of claim 27, wherein the second conductor is braided.

35. The coaxial cable of claim 27, further comprising a shielding material disposed between the second conductor and the insulator.

36. The coaxial cable of claim 35, wherein the shielding material is an aluminum/mylar tape.
